(19) United States
(12) Patent Application Publication
(10) Pub. No.: US 2025/0226707 A1
(43) Pub. Date: Jul. 10, 2025

(54) LAMINATED CORE FOR A ROTOR OF AN ELECTRIC MOTOR, AND ELECTRIC MOTOR

(71) Applicant: Brose Fahrzeugteile SE & Co. Kommanditgesellschaft, Würzburg, Würzburg (DE)

(72) Inventors: Marco GRIMM, Unterschleissheim (DE); Dominik FENTEN, Güntersleben (DE); Alexander VOLKAMER, Oberscheinfeld (DE); Horst STEEGMÜLLER, Würzburg (DE)

(21) Appl. No.: 19/092,121

(22) Filed: Mar. 27, 2025

Related U.S. Application Data
(63) Continuation of application No. PCT/EP2023/075375, filed on Sep. 15, 2023.

(30) Foreign Application Priority Data
Sep. 29, 2022 (DE) 10 2022 210 312.2

(51) Int. Cl. H02K 1/276

(52) U.S. Cl. CPC H02K 1/276

(57) ABSTRACT

A laminated core for a rotor of an electric motor has laminations arranged one above the other in the axial direction. The laminations are formed with a magnet pocket for receiving a rotor magnet, and with a core recess for reducing a laminated core moment of inertia. The core recess is formed radially inwardly from the magnet pocket. At least one of the laminations is formed with a common, contiguous laminate cut-out that forms the magnet pocket and the core recess. The rotor magnet is clampingly fixed by way of a fixing arm of the laminate that projects in the radial direction into the magnet pocket. There is also described an electric motor with a rotor that has such a laminated core.

### CROSS-REFERENCE TO RELATED APPLICATION

This application is a continuation, under 35 U.S.C. § 120, of copending International Patent Application PCT/EP2023/075375, filed Sep. 15, 2023, which designated the United States; this application also claims the priority, under 35 U.S.C. § 119, of German Patent Application DE 10 2022 210 312.2, filed Sep. 29, 2022; the prior applications are herewith incorporated by reference in their entirety.

### FIELD AND BACKGROUND OF THE INVENTION

The invention relates to a laminated core for a rotor of an electric motor. The invention also relates to an electric motor with a rotor that comprises such a laminated core.

In the case of a rotor in which the rotor magnets are arranged in magnet pockets of the laminated core, the rotor magnets are fixed in the magnet pocket in a clamped manner, for example.

In order to avoid damaging the laminated core and/or the magnets when inserting them into the pocket, and to achieve the most exact possible positioning of the rotor magnet in the respective magnet pocket to avoid unbalances, the contact area between the laminated core and the rotor magnet is suitably designed to be as small as possible.

For example, commonly assigned German published utility model DE 20 2009 007 544 U1 and its counterpart, published international application WO 2010/136107 A2 describe a laminated core in which clamping lugs protrude tangentially into the magnet pockets in order to hold the rotor magnets in a clamped manner.

Some types of rotor magnets exhibit anisotropic thermal expansion behavior. For example, neodymium-iron-boron magnets used as rotor magnets have a positive expansion coefficient in a direction parallel to their magnetization direction, but a negative expansion coefficient in a direction perpendicular thereto. At corresponding operating temperatures of the rotor, this can lead to a decrease in the frictional engagement of the clamping fixation or even no frictional engagement at all. There is a risk of the rotor magnets shifting in the respective magnet pocket.

### SUMMARY OF THE INVENTION

It is accordingly an object of the invention to provide a lamination stack for a rotor which overcomes the above-mentioned and other disadvantages of the heretofore-known devices and methods of this general type and which provides for a laminated core in which displacement of the rotor magnets in the magnet pockets is avoided or the risk thereof is at least reduced. It is a further object to specify an electric motor the rotor of which comprises such a laminated core.

With the above and other objects in view there is provided, in accordance with the invention, a laminated core for a rotor of an electric motor, the laminated core comprising:
a plurality of laminations arranged one above another in an axial direction;
the laminations being formed with a magnet pocket for receiving a rotor magnet, and with a core recess for reducing a laminated core moment of inertia, the core recess being formed radially inwardly with respect to the magnet pocket;
at least one of the laminations having a contiguous lamination recess forming the magnet pocket and the core recess, with a fixing arm of the at least one lamination protruding in a radial direction into the magnet pocket for clamping the rotor magnet.

In other words, the objects of the invention are achieved by a laminated core, as summarized, and by an electric motor with the novel laminated core.

Advantageous embodiments and developments are the subject of the dependent claims. The following description of advantageous implementations of the laminated core also apply, mutatis mutandis, to the electric motor and vice versa.

The laminated core, also known as the rotor core or lamination stack, is configured for a rotor of an electric motor. The laminated core has a number of laminations, also known as individual plates, which are arranged one above the other in an axial direction. The axial direction is therefore the direction in which the individual plates of the laminated core are stacked on top of one another, in other words the axial direction is the direction which is oriented perpendicular to the plane spanned by one of the laminations.

Centrally, i.e., in the middle, the laminated core stack is suitably formed with a shaft recess extending in the axial direction for a motor shaft. The axis through the center of the laminated core and parallel to the axial direction is referred to here and in the following as the rotor axis. In particular, the axis of symmetry corresponds to the rotor axis. In particular, the rotor axis forms the axis of rotation for the laminated core and thus for a rotor comprising the laminated core.

Accordingly, here and in the following, “radial direction” or “radial” means a direction perpendicular to the rotor axis. Here and in the following, “peripheral direction” means a direction perpendicular to the rotor axis and perpendicular to the radial direction. The peripheral direction is also referred to as the tangential direction.

The laminated core also comprises a magnet pocket, in particular one that is continuous in the axial direction, for holding a rotor magnet, in particular a permanent magnet, for example a neodymium-iron-boron magnet (NdFeB magnet), as well as a recess known as a core recess for reducing the (laminated core) moment of inertia of the laminated core. In this case, the core recess is continuous in the axial direction. The core recess is arranged radially inwards in relation to the magnet pocket. In other words, the core recess is arranged between the rotor axis and the magnet pocket.

At least one of the laminations of the laminated core has a contiguous lamination recess, by means of which, in the assembled state, i.e., together with the other laminations, both the magnet pocket and the core recess are formed. In other words, this lamination comprises a single recess for forming both the magnet pocket and the core recess. In yet other words, the lamination recess has a first portion for the magnet pocket and a second portion for the core recess, wherein the two portions are joined together, that is to say, the two portions having a common perimeter.

To clamp the rotor magnet in the radial direction, the or each lamination with a contiguous lamination recess has a fixing arm (bending arm) that protrudes into the magnet pocket in the radial direction. The fixing arm is expediently at least slightly deformable, in particular bendable in and/or against the radial direction. In the course of mounting the rotor magnet in the magnet pocket of the laminated core, the fixing arm is thus bent against the radial direction, in particular elastically.

Preferably, the shape of the fixing arm, in particular its extent in the radial direction, is selected in such a way that, in the course of mounting the rotor magnet in the magnet pocket, a deformation of the wall delimiting the magnet pocket in the radial direction towards the outside is avoided. In other words, the (bending) rigidity of the fixing arm and of the wall delimiting the magnet pocket in the radial direction are matched to each other in such a way that a force expected during the assembly of the rotor magnet only causes a deformation of the fixing arm.

In an expedient manner, the fixing arm extends from one side of such a lamination, which side delimits the lamination in the peripheral direction, into the lamination recess.

In the other laminations, there are expediently provided a first recess for forming the magnet pocket and a separate second recess for forming the core recess, which is arranged radially inwards in relation to the first recess. The first and second recesses are separated from each other by a web. The fixing arm, with the exception of its portion protruding into the magnet pocket with respect to the axial direction, is expediently arranged under the web of the other lamination(s), i.e., covered by their web.

In summary, the rotor magnet is clamped in the radial direction in the magnet pocket by means of the fixing arm of at least one of the laminations. As a result, displacement of the rotor magnet in the magnet pocket at comparatively high temperatures and/or anisotropic thermal expansion of the rotor magnet is avoided, or the risk of this is at least reduced. Advantageously, such a design also reduces a moment of inertia of the laminated core for the radial clamping of the rotor magnet. Another advantage of this design is that the magnetic flux is not influenced or is only influenced to a comparatively small extent.

In an expedient embodiment, a clamping lug (clamping tab) stands up from the side delimiting the magnet pocket in the peripheral direction and/or from the side delimiting the magnet pocket against the peripheral direction of at least one of the laminations of the laminated core. In an expedient manner, the clamping lug stands up perpendicular to the respective side. Suitably, the respective clamping lug is symmetrical, in particular with respect to an axis of symmetry which is oriented perpendicular to the side having this clamping lug and parallel to the rotor axis.

This means that the clamping lug or lugs protrudes or protrude into the magnet pocket in or against the peripheral direction, so that the rotor magnet is clamped in the peripheral direction.

Each of the clamping lugs is expediently molded onto the lamination that has them.

Suitably, the fixing arm and/or the respective clamping lug is formed by the individual plate. In a suitable embodiment, the fixing arm and/or the clamping lugs only extend in a plane perpendicular to the axial direction. The respective clamping lug or the fixing arm is therefore not deformed, in particular bent, in the axial direction, in particular during its manufacture and/or in the course of mounting the rotor magnet.

According to a preferred development, the side (side surface) of the laminations that defines the magnet pocket in the peripheral direction is inclined towards the side (side surface) that defines the magnet pocket against the peripheral direction. Expediently, these sides are each oriented perpendicular or substantially perpendicular to the peripheral direction. The angle between the two sides is suitably equal to the pole pitch angle. A web extending in the radial direction, which separates the magnet pocket from a further magnet pocket, therefore has a substantially constant thickness in the peripheral direction. On the one hand, this results in a comparatively small moment of inertia of the laminated core. On the other hand, this inclination means that a force for clamping the rotor magnet using the clamping lugs has a component in both the tangential direction and the radial direction. This enables the clamping effect in the radial direction and also a more secure clamping of the rotor magnet.

In an advantageous embodiment, the clamping lugs are arranged offset radially inwards. In other words, the clamping lugs are arranged on the radially inner area of the respective side delimiting the magnet pocket in or against the peripheral direction. In other words, the clamping lug is arranged in an area which, in the radial direction, is located halfway along the entire radial extent of the magnet pocket. In particular, the respective clamping lug is arranged in such a way that for a given magnet thickness (i.e., extent of the rotor magnet in the radial direction), the clamping lug rests against the radially inner end of the rotor magnet. On the one hand, the radial part of the clamping force is favored in this way, and on the other hand, if the side with the clamping lug is inclined, the clamping lug can be made comparatively small.

According to an advantageous development, each of the laminations that has a fixing arm has a further fixing arm for radial clamping of the rotor magnet. This means that the fixing arm and the further fixing arm protrude into the same magnet pocket in the radial direction. The fixing arm and the further fixing arm are spaced apart from each other with respect to the peripheral direction. Preferably, the two fixing arms are mirror-symmetrical to each other. It is expedient for the fixing arm to stand up from the side delimiting the lamination recess in the peripheral direction and for the further fixing arm to stand up from the side delimiting the lamination recess against the peripheral direction, or vice versa.

The second fixing arm enables redundant and therefore particularly secure clamping of the rotor magnet. Clamping using the two fixing arms makes it possible to reduce the clamping force per fixing arm compared to clamping with just one fixing arm. As a result, the risk of damage to the laminated core and/or the magnet during assembly is reduced.

According to a preferred embodiment of the laminated core, each lamination of the laminated core has a contiguous lamination recess and at least one fixing arm. As will be explained in more detail below, in particular in conjunction with a method for producing the laminated core, it is provided that the contiguous lamination recess of the respective lamination is used either to form the magnet pocket and the core recess or, alternatively, to form a further magnet pocket and a further core recess arranged radially inwards with respect to this further magnet pocket.

It is particularly expedient for the fixing arms of at least second laminations of the laminated core to protrude into the magnet pocket, i.e., into one (only) of the magnet pockets. In other words, at least the fixing arms of the second laminations protrude into the magnet pocket. The fixing arms of the laminations are spaced apart from one another in the axial direction. Thus, between the laminations of which the fixing arms protrude into the magnet pocket, there is arranged at least one lamination of the laminated core that does not have a fixing arm protruding into this magnet pocket.

In summary, in the or in each magnet pocket, the fixing arms of different laminations protruding into it are spaced apart from one another in the axial direction.

Preferably, the clamping lugs of different laminations are spaced apart from one another in the axial direction in a similar way.

This reduces the load on the rotor magnets and/or the laminated core during the assembly process.

According to a suitable embodiment of the laminated core, those laminations which have a (first) contiguous lamination recess for forming the magnet pocket and the core recess have a further contiguous lamination recess (second lamination recess) for forming both one of the further magnet pockets and also for forming one of the further core recesses arranged radially inwards with respect to this magnet pocket.

Expediently, the (first) lamination recess and the further lamination recess, i.e., the second lamination recess, are not directly adjacent with respect to the peripheral direction. Thus, at least one further first recess is preferably arranged in the peripheral direction between the first lamination recess and the second lamination recess to form only the associated magnet pocket.

Preferably, the first and second lamination recesses are arranged opposite each other, i.e., the rotor axis is arranged between the two lamination recesses. In this way, the moment of inertia for the corresponding lamination is symmetrical, so that unbalance is avoided.

If the respective lamination has two or more than two contiguous lamination recesses, these are preferably arranged evenly in the peripheral direction, in particular evenly spaced from each other in the peripheral direction. This avoids unbalance during rotation of the lamination stack.

A further aspect of the invention relates to methods for producing the laminated core in one of the variants presented above. Here, a plurality of laminations are provided, wherein at least one of the laminations has a common, contiguous lamination recess for forming the magnet pocket and the core recess arranged radially inwards with respect thereto. The laminations are arranged on top of each other, i.e., stacked on top of each other in the axial direction and expediently joined together.

Preferably, each laminated core has at least one contiguous lamination recess for forming the magnet pocket and the associated core recess. Each lamination expediently comprises further, mutually separate recesses for forming further magnet pockets or for forming further core recesses. It is particularly preferable that all laminations of the laminated core have the same design, in particular the same shape.

When stacking the individual laminations on top of each other, the individual laminations are expediently twisted relative to each other about the rotor axis in such a way that an arrangement of contiguous lamination recesses directly adjacent in the axial direction is avoided.

With the above and other objects in view there is also provided, in accordance with a further aspect of the invention, a rotor which has a laminated core in one of the variants presented above. In particular, the rotor has a magnet, in particular a permanent magnet, for example a neodymium-iron-boron magnet (NdFeB magnet), for each of the magnet pockets, wherein the magnets are each clamped in the radial direction using the fixing arms of the laminations.

In a suitable embodiment, an electric motor has such a rotor.

Other features which are considered as characteristic for the invention are set forth in the appended claims.

Although the invention is illustrated and described herein as embodied in a laminated core for a rotor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a perspective view of a laminated core for a rotor, wherein the laminated core has magnet pockets, for holding one rotor magnet each, as well as core recesses;

FIG. 2 shows a detail of one of the magnet pockets of the laminated core on an enlarged scale, wherein fixing arms protrude into this magnet pocket in the radial direction;

FIG. 3 shows a detail of a single lamination of the laminated core, wherein the latter has a contiguous lamination recess for forming both one of the magnet pockets and the core recess arranged radially inwards with respect thereto; and

FIG. 4 shows a detail of a single lamination of the laminated core in plan view, wherein this has a clamping lug for tangential clamping of the rotor magnet on the side of the lamination delimiting the magnet pocket in the peripheral direction and on the side delimiting the magnet pocket against the peripheral direction.

Corresponding parts and sizes are provided with the same reference signs and labels throughout the figures.

### DETAILED DESCRIPTION OF THE INVENTION

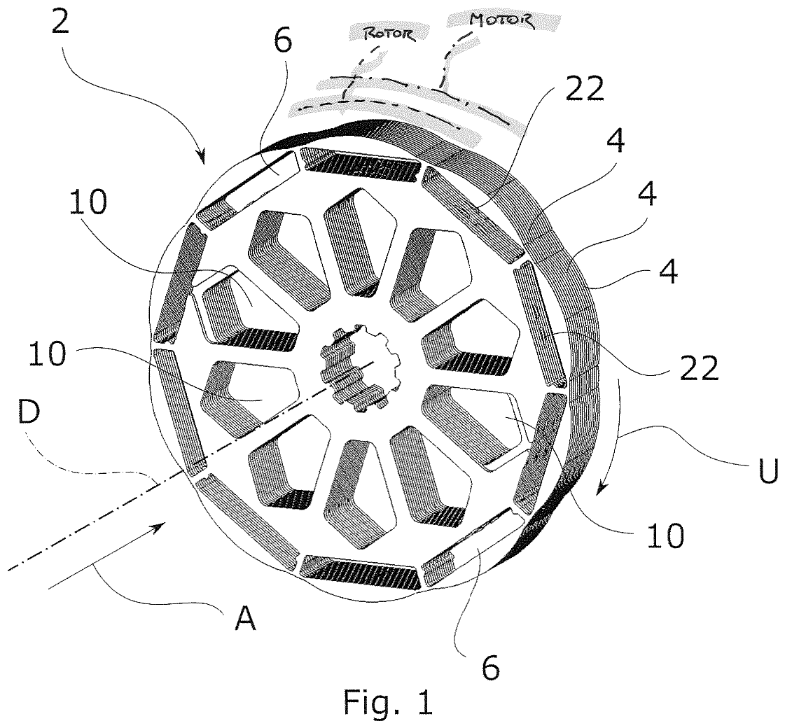

Referring now to the figures of the drawing in detail and first, in particular, to FIG. 1 thereof, there is shown a laminated core 2 for a rotor of an electric motor. The laminated core 2 comprises a plurality of (individual plate) laminations 4, which are arranged one above the other in the axial direction A. Each of the laminations 4 is rotationally symmetrical with respect to a centrally arranged axis of symmetry, wherein the axis of symmetry forms the rotor axis D, and in particular an axis of rotation provided for rotation of the laminated core 2 (or the rotor).

The laminated core 2 is formed with a number of magnet pockets 6, here for example ten, which are each provided and designed to accommodate a rotor magnet 8 (cf. FIG. 4). A core recess 10 is arranged between the rotor axis D and the magnet pockets 6 in order to reduce the moment of inertia of the laminated core 2. In other words, a respective core recess 10 is arranged radially on the inside of each of the magnet pockets 6. The radial direction labeled “R” is a direction perpendicular to the rotor axis D.

The magnet pockets 6 and the core recesses 10 are formed by recesses 16, 12, 14 in the individual laminations 4. These recesses 12, 14, 16 are aligned in the axial direction A, so that the magnet pockets 6 and the core recesses 10 are formed continuously in the axial direction.

The recesses 12, 14 and 16 for forming the magnet pockets 6 and the core recesses 10 are formed in one of two variants.

On the one hand, the respective lamination 4 has the (first) recess 12 for forming one of the magnet pockets 6. This recess 12 is closed. For the formation of the adjacent magnet pocket 6 in the peripheral direction U, the respective lamination 4 has a further first recess 12, wherein the first recesses 12 directly adjacent in the peripheral direction U are separated from one another by means of a longitudinal web 18. Furthermore, the respective first recess 12 is separated from the respective radially inwardly arranged second recess 14 by a transverse web 20 of the corresponding lamination 4. The first recess 12 and the second recess 14 are therefore not contiguous, but separate openings in the respective lamination 4.

On the other hand, the respective lamination 4 comprises a contiguous lamination recess 16 for forming one of the magnet pockets 6 and for forming the core recess 10 arranged radially inwards with respect to this magnet pocket 6. In other words, in this case the first recess 12 and the second recess 14 are connected to one another. In yet other words, the first and the second recess 12 are formed as a single common recess, namely as the lamination recess 16.

At least one of the laminations 4, preferably-and as shown in the example in the figures-each of the laminations 4 of the laminated core 2, has at least one contiguous lamination recess 16 for forming one of the magnet pockets 6 and for forming the core recess 10 arranged radially inwards with respect to this magnet pocket 6. As can be seen comparatively well in particular FIG. 1 in the case of the first lamination 4 in the axial direction, each of the laminations comprises two contiguous lamination recesses 16, wherein these lamination recesses 16 are arranged opposite one another, in other words wherein the rotor axis D is arranged between these lamination recesses 16. Thus, magnet pockets 6 and two core recesses 10 are formed by means of these two lamination recesses 16.

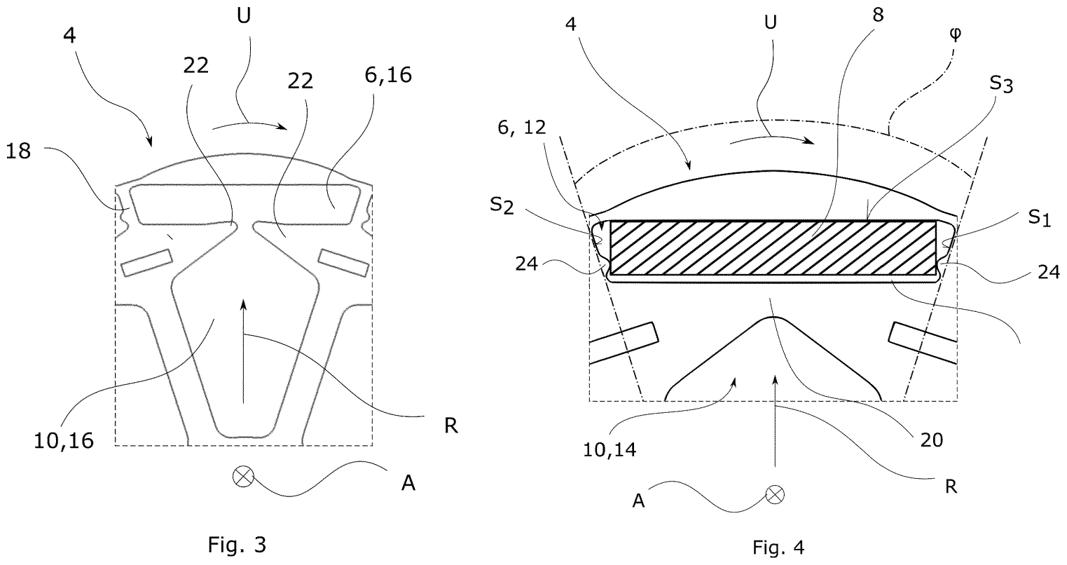

As can be seen comparatively well in FIG. 1 and FIG. 3 in particular, two fixing arms 22 protrude into each of the lamination recesses 16. One of these fixing arms 22 protrudes towards that side S1 of the lamination 4 which delimits the magnet pocket 6 in the peripheral direction U, and extends from this side substantially in the opposite direction to the peripheral direction U. The other fixing arm 22 protrudes towards that side S2 of the lamination 4 which delimits the magnet pocket 6 in the opposite direction to the peripheral direction U, and extends from this side substantially in the peripheral direction U. The other fixing arm 22 protrudes towards that side S2 of the lamination 4 which delimits the magnet pocket 6 in the opposite direction to the peripheral direction U, and extends from this side substantially in the peripheral direction U. The fixing arms 22 protrude into the corresponding magnet pocket 6 at the free end. The fixing arms 22 are arranged in such a way that a corresponding rotor magnet 8 is held in a clamped manner between them and the side S3 of the lamination 4, thus of the magnet pocket 6, delimiting the lamination recess 16 or the first recess 12 in the radial direction R.

In summary, the fixing arms 22 are spaced apart from each other in the peripheral direction U. In other words, the transverse web 20 is interrupted in the peripheral direction to form the two fixing arms 22, i.e., is not continuous from the side S1 to the side S2, wherein the fixing arms 22 are shaped or deformed such that they protrude in the radial direction R into the corresponding magnet pocket 6, and wherein the fixing arms 22 are preferably thinner in radial direction R compared to the transverse webs 20.

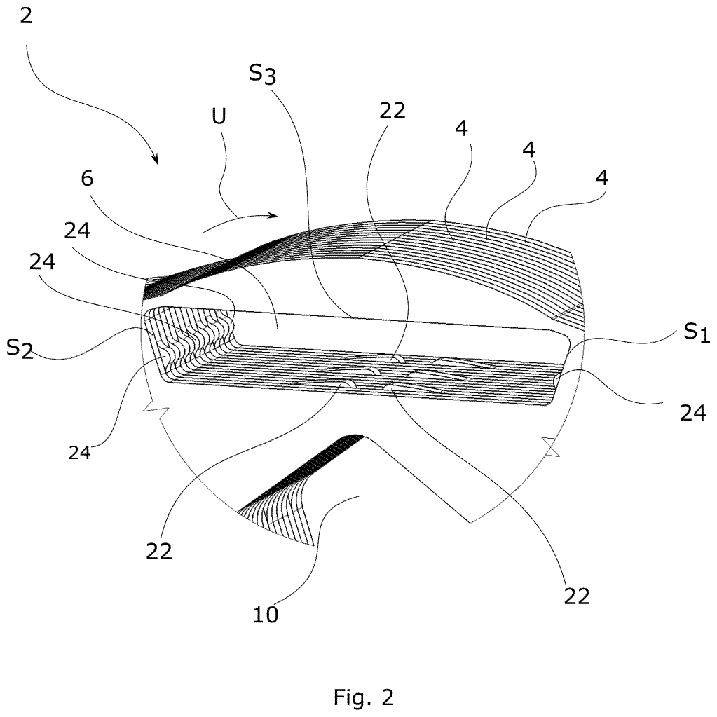

According to the exemplary embodiment presented here, the laminations 4 of the laminated core are the same shape with respect to their recesses 12, 14 and 16. As can be seen in FIGS. 1 and 2, at least the fixing arms 22 of two of the laminations 4 protrude into each of the magnet pockets 6. The laminations 4 of the laminated core 2 are twisted here relative to one another in such a way that those fixing arms 22 which protrude into a common magnet pocket 6 are arranged at a distance from one another in the axial direction A.

As can also be seen in particular in FIGS. 1 and 2, the fixing arms 22 of each lamination 4, with the exception of their portion protruding into the respective magnet pocket 6, are covered in the axial direction A by one of the transverse webs 20 of the lamination 4 arranged above and/or below it.

In particular, the longitudinal webs 18, which separate the first recesses 12 or the first recesses 12 and the lamination recesses 18 from one another in the peripheral direction U, have a substantially constant thickness in the peripheral direction U. The side S1, which delimits the magnet pocket 6 in the peripheral direction U, and the side S2, which delimits the magnet pocket 6 against the peripheral direction U, each extend substantially in the radial direction R. Thus, the side S1 and the side S2 are inclined relative to one another and include the pole pitch angle φ, which is equal to 360° divided by the number of magnet pockets 6.

With respect to the peripheral direction U at each second recess 12, 16 (i.e., at each other recess), by means of which one of the magnet pockets 6 is formed, a clamping lug 24 stands vertically up from the side S1 delimiting the respective magnet pocket 6 in the peripheral direction U and from the side S2 delimiting this magnet pocket 6 against the peripheral direction U in each case. The clamping lugs 24 protrude into this magnet pocket 6 in or against the peripheral direction U, so that the rotor magnet can be clamped with respect to the peripheral direction U by means of the clamping lugs 24.

The laminations 4 of the laminated core 2 are twisted relative to one another in such a way that those clamping lugs 24 which protrude into a common magnet pocket 6 are arranged at a distance from one another in the axial direction A.

The inclination of the two sides S1 and S2 relative to each other advantageously results in a (clamping) force when the rotor magnet 8 is clamped, see also FIG. 4, which force has a component in the radial direction R, so that a clamping effect in the radial direction R is improved.

Furthermore, as can be seen in particular in FIG. 4, the clamping lugs 24 are arranged on the radially inner area of the sides S1 and S2. In other words, the clamping lugs 24 are arranged offset radially inwards. Consequently, the clamping lugs lie in a radially inner area of the rotor magnet 8.

The clamping lugs 24 and the fixing arms 22 extend, in particular also with the rotor magnets accommodated in the magnet pockets, only in a plane perpendicular to the axial direction A. The clamping lugs 24 and the fixing arms 22 are therefore not intended to be bent in or against the axial direction A in order to clamp the respective rotor magnet 8.

In a manner not shown, a rotor comprises the laminated core 2 shown in the figures and the rotor magnets 8 held in its magnet pockets 6. Furthermore, in a manner not further shown, an electric motor comprises a stator and such a rotor.

It will be understood that the invention is not limited to the exemplary embodiments described above. Rather, other variants of the invention can also be derived from this within the scope of the claims by a person skilled in the art without departing from the subject matter of the invention. In particular, the individual features described in conjunction with the exemplary embodiments and/or in the claims can also be combined with one another in other ways without departing from the subject matter of the invention.

The following is a summary list of reference numerals and the corresponding structure used in the above description of the invention:
2 laminated core
4 lamination
6 magnet pocket
8 rotor magnet
10 core recess
12 first recess of the lamination
14 second recess in the lamination
16 lamination recess/contiguous recess
18 longitudinal web
20 transverse web
22 fixing arm
24 clamping lug
A axial direction
φ pole pitch angle
D rotor axis
R radial direction
S1 side of the lamination
S2 side of the lamination
S3 side of the lamination
U peripheral direction/tangential direction

1. A laminated core for a rotor of an electric motor, the laminated core comprising:
a plurality of laminations arranged one above another in an axial direction;
said laminations being formed with a magnet pocket for receiving a rotor magnet, and with a core recess for reducing a laminated core moment of inertia, said core recess being formed radially inwardly with respect to said magnet pocket;
at least one of said laminations having a contiguous lamination recess forming said magnet pocket and said core recess, with a fixing arm of said at least one lamination protruding in a radial direction into said magnet pocket for clamping the rotor magnet.

2. The laminated core according to claim 1, wherein at least one of said laminations is formed with a clamping lug projecting from at least one of a side delimiting said magnet pocket in a peripheral direction or from a side delimiting said magnet pocket in a direction opposite the peripheral direction.

3. The laminated core according to claim 2, wherein said clamping lug projects perpendicularly from the side delimiting said magnet pocket.

4. The laminated core according to claim 2, wherein the side which delimits the magnet pocket in the peripheral direction is inclined with respect to the side which delimits the magnet pocket in the direction opposite the peripheral direction.

5. The laminated core according to claim 2, wherein said clamping lugs are arranged offset radially inwardly.

6. The laminated core according to claim 1, wherein said at least one lamination having said fixing arm has a further fixing arm, and wherein said fixing arm and said further fixing arm for clamping the rotor magnet protrude into said magnet pocket at a distance from one another with respect to the peripheral direction.

7. The laminated core according to claim 1, wherein each of said plurality of laminations has a contiguous lamination recess for forming said magnet pocket and said core recess or for forming a further magnet pocket and a further core recess, and a fixing arm.

8. The laminated core according to claim 7, wherein said fixing arms of at least two of said laminations protrude into said magnet pocket, and wherein said fixing arms protruding into said magnet pocket are spaced apart from one another in the axial direction.

9. The laminated core according to claim 1, wherein said at least one lamination with said contiguous lamination recess has a further contiguous lamination recess for forming a further magnet pocket and a core recess radially inwardly from said further magnet pocket.

10. The laminated core according to claim 1, wherein each of said laminations with said contiguous lamination recess has a further contiguous lamination recess for forming a further magnet pocket and a core recess radially inwardly from said further magnet pocket.

11. The laminated core according to claim 2, wherein at least one of said clamping lugs or said fixing arm extend only in a plane perpendicular to the axial direction.

12. An electric motor, comprising a rotor having a laminated core according to claim 1.
